(19) United States
(12) Patent Application Publication
(10) Pub. No.: US 2017/0272490 A1
(43) Pub. Date: Sep. 21, 2017

(54) System and Method to Process the Slices of the Video Data to Achieve Low Latency Video Streaming and Display

(71) Applicant: PathPartner Technology Private Limited, Bangalore (IN)

(72) Inventors: Jithin Suresh Kudappananickal, Bangalore (IN); Prabhuraj Tavag, Bangalore (IN); Ramya Ravichandran, Bangalore (IN); Bhargav Adigarla, Bangalore (IN)

(73) Assignee: PathPartner Technology Pvt. Ltd., Bangalore (IN)

(21) Appl. No.: 15/243,214

(22) Filed: Aug. 22, 2016

(30) Foreign Application Priority Data
Mar. 17, 2016 (IN) 201641009328

(51) Int. Cl. H04L 29/06

(52) U.S. Cl. CPC H04L 65/607; H04L 65/608

(57) ABSTRACT

The present invention discloses a system and method to process the slices of the video data to achieve low latency in video streaming and displaying. The system comprises of a capture module, a process module, an encoding module, a streaming module and a decoder and display module. The system processes the slices of the video data to achieve the low latency in video streaming by parallelizing the data processing in reception and displaying therein. The system captures, processes, encodes, transmits, decodes and displays the video data in slices in lowest possible time using the less number of resources. The system provides better optimization for the slices in buffer memory by providing pipeline operations.

### TECHNICAL FIELD OF THE INVENTION

The present invention relates to a system and method to process the slices of the video data to achieve the low latency in video streaming by parallelizing the data processing in reception and displaying therein.

### BACKGROUND OF THE INVENTION

In the present day market scenario, the demand for high-resolution and high-quality images has increased in various fields of applications such as Television (TV), photography, media, DV (Digital Video) cameras, HDTV (High Definition Tele Vision), satellite TV (Tele Vision), set-top boxes, internet video streaming, digital cameras, cellular telephones, video jukeboxes, high-end displays, personal video recorders etc. In these applications, the video encoding portion currently delays the start of video frame transmission until the video frame is fully encoded. In video encoder implementation, the digital video frames are segmented into video slices at the encoder side to reduce the impact of data losses during transmission. Each video slice is independently encoded and decoded. The low latency in streaming the images or videos is achieved using the present invention.

Various types of conventional systems that achieve the low latency video streaming of the video data are known in the prior art. The EP Patent document. 2811742 A4 describes the video encoding method, video decoding method, and device using same. The claimed method comprises the steps of, specifying a tile and a slice by partitioning an inputted picture; performing encoding on the basis of the tile and the slice; and transmitting the encoded video information, wherein the picture is partitioned into one or more tiles and one or more slices, and the restrictions for parallel processing can be applied to the tiles and the slices.

The U.S. Pat. No. 8,582,656 B2 describes a method and system for video encoding and decoding. The claimed method and system provides for encoding and decoding a video stream. Each picture in a video stream can be divided into slices, each of which contains a contiguous row of macro blocks. All the blocks corresponding to a single video component within each slice can then be used as the basis for encoding the picture. By decomposing each picture into slices, the video stream can be efficiently converted for displays of varying size and/or quality. The encoded bit stream can include a slice table to allow direct access to each slice without reading the entire bit stream. Each slice can also be processed independently, allowing for parallelized encoding and/or decoding.

The Chinese Patent document CN104205834 describes method and apparatus for video encoding for each spatial sub-area, and method and apparatus for video decoding for each spatial sub-area. The claimed method relates to a technique for video encoding and decoding for each spatial sub-area. Provided is a method for video encoding for each spatial sub-area comprising: partitioning a picture into two or more tiles and at least one slice segment; encoding each tile separately from other tiles; and encoding, for each slice segment in the current tile, maximum encoding units comprised the current tile from among maximum encoding units comprised in the current slice segment.

However, the use of claimed systems and methods do not disclose the processing of slices in the video data. Typically, the system encodes, decodes and displays the video data to improve the latency in streaming thereof. The referred patent documents do not discuss the processing of slices into packets and displaying the processed packets by unpacking therein. Typically, the system does not provide the parallelization of data processing in reception and displaying the video data.

Hence, there is need for a system and method to process the slices of the video data to achieve the low latency in video streaming by parallelizing the data processing in reception and displaying therein.

### SUMMARY OF THE INVENTION

The present invention overcomes the drawbacks in the prior art and provides a system to provide low latency video streaming over IP (Internet Protocol) and display or a system and method to process the slices of the video data to achieve low latency video streaming. The system comprises of a capture module, a process module, an encoding module, a streaming module and a display module. The capture module captures and converts the video data into a plurality of slices using a sensor drive. The process module configured to process the slices using an Imaging Subsystem (ISS) device. The ISS provides pipeline operations to the slices. The encoding module encodes and stores the processed slices into one or more packets. The streaming module is configured to stream the encoded slices/bit-stream/packets using a processor. The display module receives, unpacks and displays the encoded packets by decoding therein using a Real Time Transport protocol (RTP).

In a preferred embodiment of the invention, the display module is further configured to decode and store the packets at the buffer to attain pipeline operations using the processor.

In a preferred embodiment of the invention, the capture module is further configured to use the pipeline IPIPE (Imaging PIPE), if the image quality criteria are not met with the earlier pipeline.

In a preferred embodiment of the invention, the streaming module is further configured to optimize the encoded slices to improve the latency.

The invention also provides a method to process the slices of the video data to achieve low latency video streaming. In most preferred embodiment, the method includes the step of capturing the video data using a sensor driver. The captured video data is converted into a plurality of slices. After converting the video data into the slices, the slices are processed using VPSS (Video Processing Sub System) processor. The VPSS processor provides pipeline operations to the processed slices. After processing the slices, the processed slices are encoded and stored into one or more packets. The encoded slices/bit-stream/packets are streamed using a processor. Further, the encoded slices or packets are decoded using a media processor. Finally, the decoded packets are displayed by unpacking therein using a Real Time Transport protocol (RTP).

In a preferred embodiment of the invention, the method further displays the packets by decoding and storing at the buffer in a sequential order.

In a preferred embodiment of the invention, the method further optimizes the encoded slices to improve the latency rate of the streaming.

The present invention has been designed to have the reduced video data streaming latency, which results in memory saving. The invented system provides better optimization for slices in buffer memory by providing pipeline operations. The system processes the slices in lowest possible time by using the less number of resources.

The present invention provides a system which is simple, time saving, resource efficient, and cost effective. The invention may be used in digital image capture units such as digital video cameras, HDTV, satellite TV, set-top boxes, internet video streaming, digital cameras, cellular telephones, video jukeboxes, high-end displays, personal video and recorders etc.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates the block diagram to process the slices of the video data to achieve low latency video streaming and display, according to one embodiment of the invention.

FIG. 2 illustrates the method to process the slices of the video data to achieve low latency video streaming and display, according to one embodiment of the invention.

### DETAILED DESCRIPTION OF THE INVENTION

Reference will now be made in detail to the description of the present subject matter, one or more examples of which are shown in figures. Each embodiment is provided to explain the subject matter and not a limitation. These embodiments are described in sufficient detail to enable a person skilled in the art to practice the invention, and it is to be understood that other embodiments may be utilized and that logical, physical, and other changes may be made within the scope of the embodiments. The following detailed description is, therefore, not be taken as limiting the scope of the invention, but instead the invention is to be defined by the appended claims.

The present invention discloses a system and method to process the slices of the video data to achieve low latency in video streaming and displaying. The system comprises of a capture module, a process module, an encoding module, a streaming module and a display module. The system captures and converts the video data into a plurality of slices using a sensor driver. The slices are processed using a processor. The processor provides pipeline operations to the processed slices. The encoding module encodes and stores the processed slices into one or more packets using. The encoded packets are streamed and decoded using the streaming module. The display module displays the decoded packets by unpacking thereof using a Real Time Transport protocol (RTP). The system processes the slices of the video data to achieve the low latency in video streaming by parallelizing the data processing in reception and displaying therein.

The present invention has been designed to have the reduced video data streaming latency, which results in memory saving. The invented system provides better optimization for slices in buffer memory by providing pipeline operations. The system processes the slices in lowest possible time by using the less number of resources.

The present invention provides a system which is simple, saves time, resource efficient and cost effective. The device may be used in digital image capture units such as digital video cameras, HDTV, satellite TV, set-top boxes, interne video streaming, digital cameras, cellular telephones, video jukeboxes, high-end displays, personal video and recorders etc.

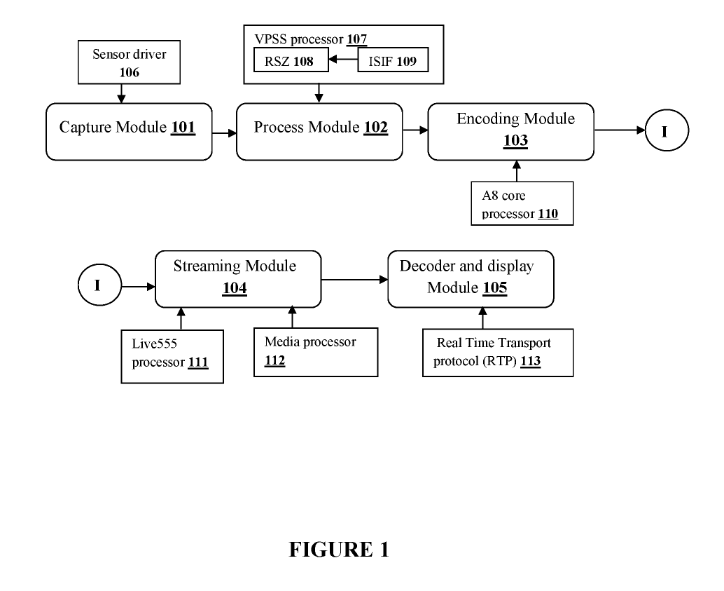

FIG. 1 illustrates the block diagram to process the slices of the video data to achieve low latency video streaming and display, according to one embodiment of the invention. The system 100 comprises a capture module 101, a process module 102, an encoding module 103, a streaming module 104 and a display module 105. The capture module 101 captures and converts the video data into a plurality of slices using a sensor driver 106. The process module 102 is configured to process the slices using an ISS device which is controlled by the VPSS processor. The VPSS processor 107 provides pipeline operations to the processed slices. The encoding module 103 encodes and stores the processed slices into one or more packets. The capture is done via ISIF (Image Sensor Interface) 109 and the resolution may be modified using RSZ (Resizer) 108. The RTSP (Real Time Streaming Protocol) module 103 uses A8 core processor 110 to process the stored packets. The processed packets are stored in the DDR SDRAM (Double Data Rate Synchronous Dynamic Random-Access Memory). The streaming module 104 is configured to stream the encoded slices or bit-stream or packets through a live555 processor 111. Further, the encoded slices or packets are decoded using a media processor 112. The display module 105 displays the decoded slices or packets by unpacking thereof using a Real Time Transport protocol (RTP) 113.

In a preferred embodiment, the display module 105 using media processor 112 runs a Real Time Streaming Protocol (RTSP) to unpack the RTP packets after receiving from the streaming module. Once unpacking is done, the processor gives the encoded bit-stream without the NAL (Network Abstraction Layer) start bytes. The display module 105 further appends and submits the NAL start bytes to the buffer memory to attain the pipe operations for displaying therein using IPC mechanism. The display module 105 is further configured to decode and store the packets at the buffer to attain pipeline operations using the processor.

In the preferred embodiment, the capture module 101 is further configured to use the pipeline IPIPE, if the image quality criteria are not met with the earlier pipeline.

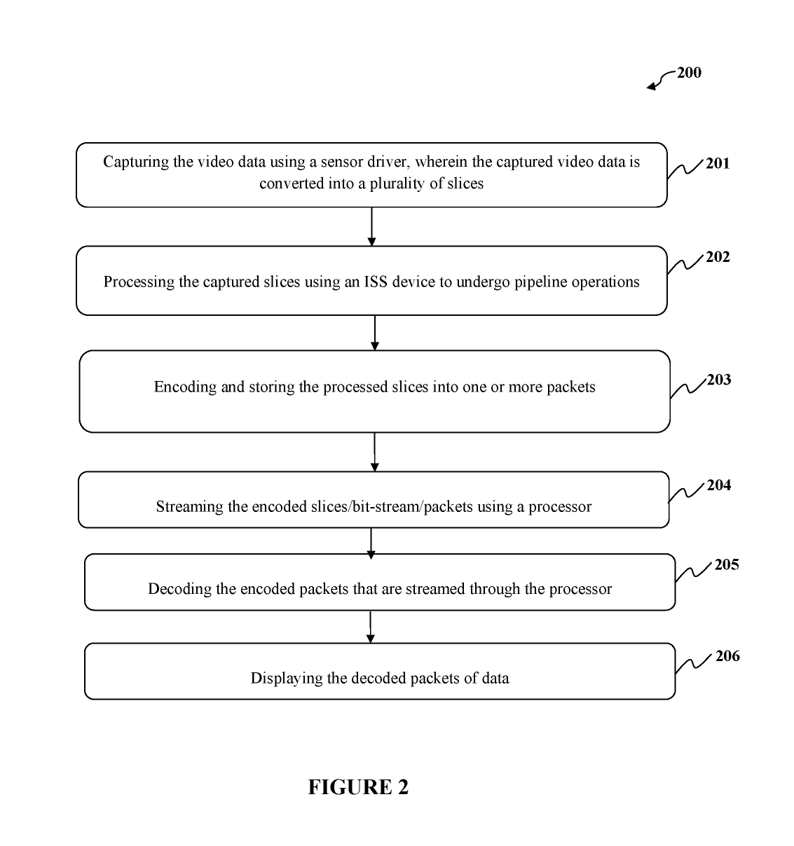

FIG. 2 illustrates the method to process the slices of the video data to achieve low latency video streaming and display, according to one embodiment of the invention. In the preferred embodiment, at step 201, the video data is captured using a sensor driver. The captured video data is converted into a plurality of slices. The capture is done via ISIF and the resolution may be modified using RSZ. After converting the video data into slices, at step 202 the slices are processed using VPSS processor. The VPSS processor provides pipeline operations to the processed slices. After processing the slices, at step 203, the processed slices are encoded. At step 204, the encoded slices/bit-stream/packets are streamed using a live555 processor. Further, at step 205, the encoded slices or packets are decoded using a media processor. Finally, at step 206, the packets of data via Real Time Transport protocol (RTP) are displayed after processing.

In the preferred embodiment, the method 200 further displays the packets by decoding and storing at the buffer in a sequential order. The method 200 further optimizes the encoded slices to improve the latency rate of the streaming.

The present invention provides a device which is simple, time saving, resource efficient, and cost effective. The invention may be used in digital image capture units such as digital video cameras, HDTV, satellite TV, set-top boxes, Internet video streaming, digital cameras, cellular telephones, video jukeboxes, high-end displays, personal video and recorders etc.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

We claim:

1) A system to achieve low latency video streaming and display by processing the slices of the video data, the system comprises:
a) a capture module captures and converts the video data into a plurality of slices using a sensor driver;
b) a process module configured to process the slices using a ISS device, wherein the ISS provides pipeline operations to the slices;
c) an encoding module encodes and RTSP stores the processed slices into one or more packets. The capture is done via ISIF and the resolution can be modified using RSZ.
d) a streaming module configured to stream the encoded slices/bit-stream/packets using a processor; and
e) a decoder and display module gets the packets via Real Time Transport protocol (RTP) and displays the decoded data.

2) The system as claimed in claim 1, wherein the capture module is further configured to use the pipeline IPIPE, if the image quality criteria are not met with the earlier pipeline.

3) The system as claimed in claim 1, the streaming module is further configured to optimize the encoded slices to improve the latency.

4) A method to achieve low latency video streaming and display by processing the slices of the video data, the method comprising the steps of:
a) capturing the video data using a sensor driver, wherein the captured video data is converted into a plurality of slices;
b) processing the captured slices using a Imaging Subsystem(ISS) device to undergo pipeline operations;
c) encoding and storing the processed slices into one or more packets;
d) streaming the encoded slices/bit-stream/packets using a processor;
e) decoding the encoded packets through the processor; and
f) displaying the decoded packets of data.

5) The method as claimed in claim 4, wherein the method further displays the packets by decoding and storing at the buffer in a sequential order.

6) The method as claimed in claim 5, wherein the method further optimizes the encoded slices to improve the latency rate of the streaming.
